(19) United States
(12) Patent Application Publication
(10) Pub. No.: US 2011/0004452 A1
(43) Pub. Date: Jan. 6, 2011

(54) METHOD FOR COMPENSATION OF RESPONSES FROM EDDY CURRENT PROBES

(76) Inventors: Sanghamithra Korukonda, Malleswaram (IN); Sandeep Dewangan, Karnataka (IN); Preeti Pisupati, Bangalore (IN); William Stewart McKnight, Hamilton, OH (US); Gigi Gambrell, West Chester, OH (US); Ui Suh, Cincinnati, OH (US); Changting Wang, Schenectady, NY (US)

Correspondence Address: General Electric Company;GE Global Patent Operation, 2 Corporate Drive, Suite 648, Shelton, CT, 06484, US

(21) Appl. No.: 12/810,734

(22) PCT Filed: Dec. 31, 2007
(86) PCT No.: PCT/IN07/00622

§ 371 Date: Sep. 18, 2010

(51) Int. Cl. G06F 17/11; G06F 17/10

(52) U.S. Cl. 703/2

(57) ABSTRACT

A method of inspecting a component using an eddy current array probe (ECAP) is provided. The method includes scanning a surface of the component with the ECAP, collecting, with the ECAP, a plurality of partial defect responses, transferring the plurality of partial defect responses to a processor, modeling the plurality of partial defect responses as mathematical functions based on at least one of a configuration of elements of the ECAP and a resolution of the elements, and producing a single maximum defect response from the plurality of partial defect responses.

### BACKGROUND OF THE INVENTION

The field of the invention relates generally to non-destructive testing of components, and more particularly to methods to compensate responses from an eddy current array probe (ECAP).

Eddy current (EC) inspection devices may be used to detect abnormal indications in a component such as, but not limited to, a gas turbine engine component. For example, known EC inspection devices may be used to detect cracks, dings, raised material, and/or other imperfections on a surface and/or within the component. EC inspection devices may also be used to evaluate material properties of the component including the conductivity, density, and/or degrees of heat treatment that the component has encountered.

EC images are typically generated by scanning a part surface with a single element EC coil. An imperfection on, or within, the part surface is detected by the EC element when it traverses the complete extent of the imperfection. At least some known eddy current array probe (ECAP) imaging, however, uses an array of EC elements that scan the surface of a part in one direction. Using an array of EC elements reduces inspection time and increases inspection speed as compared to a single element scan. However, ECAP images require processing prior to flaw detection. Specifically, processing is necessary because an imperfection detected during a scan using ECAP may be seen only in partial by several EC element coils, rather than being seen completely by only one EC element as occurs with single-coil EC imaging. Processing techniques for certain arrays of EC elements may use a look-up table based approach in which a ratio of amplitudes of various elements are used to determine the presence of a flaw. However, such a processing technique is process dependent, and may be susceptible to look-up table errors.

In addition, the use of known EC probes may be limited by the fact that a prior knowledge of crack orientation is required. Because of the directionality of differential eddy current probes, if more than one flaw orientation is anticipated, the test specimen may require repeated scanning in different orientations to detect the flaws. Such repeated scanning is time consuming and may be inefficient.

### BRIEF DESCRIPTION OF THE INVENTION

In one embodiment, a method of inspecting a component using an eddy current array probe (ECAP) is described. The method includes scanning a surface of the component with the ECAP, collecting, with the ECAP, a plurality of partial defect responses, transferring the plurality of partial defect responses to a processor, modeling the plurality of partial defect responses as mathematical functions based on at least one of a configuration of elements of the ECAP and a resolution of the elements, and producing a single maximum defect response from the plurality of partial defect responses.

In another embodiment, a method of estimating a length of a defect detected by an eddy current array probe (ECAP) is described. The method includes modeling the plurality of partial defect responses received from the eddy current probe as mathematical functions based on at least one of a configuration of elements of the ECAP and a resolution of the elements, applying a compensation technique to the plurality of partial defect responses to produce a single maximum defect response, and determining the estimated length of the defect based on the single maximum defect response.

In another embodiment, a system for non-destructive testing of a component, the system configured to detect the presence of defects on a surface of and/or within the component and estimate a length of at least one defect. The system includes an eddy current (EC) probe configured to produce an EC image of the component, and a processing device coupled to the EC probe. The processing device configured to receive the EC image from the EC probe and apply at least one compensation technique to the EC image to obtain a single maximum defect response.

### BRIEF DESCRIPTION OF THE DRAWINGS

FIG. 1 is a schematic diagram of an exemplary eddy current surface flaw detection system;

FIG. 2 illustrates an exemplary Sense External Eddy Current Array Probe (ES ECAP) that may be used with the system shown in FIG. 1;

FIG. 3 is an exemplary ECAP footprint produced from defect response data that may be collected by the ES ECAP shown in FIG. 2;

FIG. 4 illustrates exemplary results of a sum of squares compensation technique;

FIG. 5 illustrates exemplary result of a variable phase compensation technique;

FIG. 6 illustrates an exemplary Long Standard Probe Eddy Current Array Probe (LSP ECAP);

FIG. 7 is an exemplary plot 200 produced from exemplary defect response data collected by LSP ECAP;

FIG. 8 illustrates exemplary results of a sum of squares compensation technique and a variable phase compensation technique when applied to a footprint produced by a LSP ECAP;

FIG. 9 illustrates an exemplary omni-directional ECAP;

FIG. 10 is a plan view of an exemplary component that includes a plurality of defects of varying orientations;

FIG. 11 illustrates four exemplary footprints produced from defect response data collected by an omni-directional ECAP;

FIG. 12 illustrates four exemplary A-scans produced from the footprints of FIG. 11; and

FIG. 13 is a flow chart of an exemplary compensation technique for use with partial defect responses produced by an omni-directional ECAP.

### DETAILED DESCRIPTION OF THE INVENTION

In one embodiment, an automated defect recognition (ADR) process for an eddy current array probe (ECAP) is described herein. ECAP imaging uses an array of eddy current (EC) elements that scan the surface of a component to generate an image. ECAP imaging facilitates reducing inspection time as compared to inspection with a single-coil element. However, images obtained by an ECAP have to be processed prior to flaw detection and characterization since a defect seen during a scan using ECAP is seen only in part by several element coils, and an imperfection seen during a scan using single-coil EC imaging is partially seen at each scan increment of a raster scan.

In an exemplary embodiment, the ADR process automates the data processing procedure. The ADR method also facilitates reliable flaw recognition and characterization, while minimizing false defect identification. In the exemplary embodiment, signal processing algorithms are used to identify potential defect signals from the ECAP images and to estimate the size and orientation of the defects. The algorithms establish criteria used to estimate the orientation of the defect and to apply appropriate corrections in order to facilitate maximizing the response from the defect. In addition, the algorithms may function without the use of reference images, look-up tables, or any other a priori information.

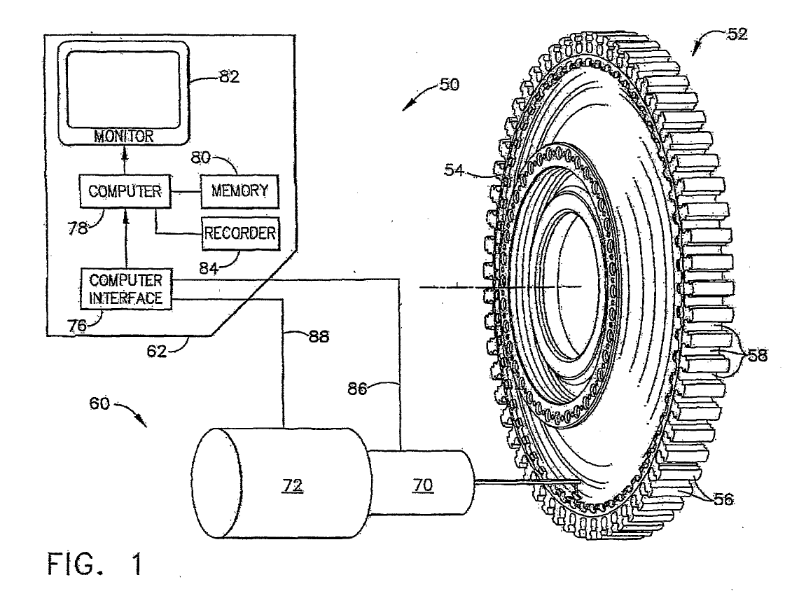

FIG. 1 is a schematic diagram of an exemplary eddy current flaw detection system 50 that may be used to inspect a component 52 such as, but not limited to, a gas turbine engine disk 54. In the exemplary embodiment, disk 54 includes a plurality of dovetail posts 56 and a plurality of circumferentially-spaced dovetail slots 58 defined between adjacent pairs of posts 56.

Although the methods and apparatus herein are described with respect to posts 56 and dovetail slots 58, it should be appreciated that the methods and apparatus can be applied to a wide variety of components. For example, the present invention may be used with a component 52 having any shape, size, and/or configuration. Examples of such components may include, but are not limited to only including, components of gas turbine engines such as seals, flanges, turbine blades, turbine vanes, and/or flanges. The component may be fabricated from any base material such as, but not limited to, nickel-base alloys, cobalt-base alloys, titanium-base alloys, iron-base alloys, and/or aluminum-base alloys. More specifically, although the methods and apparatus herein are described with respect to aircraft engine components, it should be appreciated that the methods and apparatus can be applied to, or used to inspect, a wide variety of components used within a steam turbine, a nuclear power plant, an automotive engine, or any other mechanical components.

In the exemplary embodiment, detection system 50 includes a probe assembly 60 and a data acquisition/control system 62. Probe assembly 60 includes an eddy current (EC) coil/probe 70 and a probe manipulator 72 that is coupled to probe 70. Eddy current probe 70 and probe manipulator 72 are each electrically coupled to data acquisition/control system 62 such that control/data information can be transmitted to/from EC probe 70 and/or probe manipulator 72 and/or data acquisition/control system 62. In an alternative embodiment, system 50 also includes a turntable (not shown) that selectively rotates component 52 during the inspection procedure.

Data acquisition/control system 62 includes a computer interface 76, a computer 78, such as a personal computer with a memory 80, and a monitor 82. Computer 78 executes instructions stored in firmware (not shown), and is programmed to perform functions described herein. As used herein, the term “computer” is not limited to just those integrated circuits referred to in the art as computers, but rather broadly refers to computers, processors, microcontrollers, microcomputers, programmable logic controllers, application specific integrated circuits, and other programmable circuits, and these terms are used interchangeably herein.

Memory 80 represents one or more volatile and/or nonvolatile storage facilities that shall be familiar to those skilled in the art. Examples of such storage facilities often used with computer 78 include, but are not limited to, solid-state memory (e.g., random access memory (RAM), read-only memory (ROM), and flash memory), magnetic storage devices (e.g., floppy disks and hard disks), and/or optical storage devices (e.g., CD-ROM, CD-RW, and DVD). Memory 80 may be internal to, or external from, computer 78. Data acquisition/control system 62 also includes a recording device 84 such as, but not limited to, a strip chart recorder, a C-scan, and/or an electronic recorder that is electrically coupled to either computer 78 and/or eddy current probe 70.

In use, a component 52, such as disk 54, is mounted on a fixture (not shown) that secures the component 52 in place during inspection. Eddy current probe 70 is selectively positioned within dovetail slots 58 to facilitate scanning substantially all of the interior of dovetail slots 58 during inspection. In the exemplary embodiment, probe manipulator 72 is a six-axis manipulator. EC probe 70 generates electrical signals in response to eddy currents induced within the surfaces of dovetail slots 58 during scanning by probe 70. Electrical signals generated by EC probe 70 are received by data acquisition/control system 62 via a data communications link 86 and are stored in memory 80 and/or recorder 84. Computer 78 is also coupled to probe manipulator 72 by a communications link 88 to facilitate controlling the scanning of disk 54. A keyboard (not shown) is electrically coupled to computer 78 to facilitate operator control of the inspection of disk 54. In the exemplary embodiment, a printer (not shown) may be provided to generate hard copies of the images generated by computer 78.

In the exemplary embodiment, system 50 may be used to perform any kind of eddy current inspection, such as conventional inspection, single-coil inspection, or ECAP inspection. System 50 automatically scans the surface of component 52 and stores the acquired data in the form of images. The defect recognition algorithms will then be employed by computer 78 to identify and characterize any flaw (if present) on the surface of component 52.

When an EC inspection is performed, a magnetic field is generated by a drive coil. Such generating may include, but is not limited to only, supplying an alternating current to a drive coil. The drive coil is positioned adjacent to a surface of a component to be tested. When the drive coil is positioned, the drive coil is oriented substantially parallel to the surface being tested. Such an orientation of the drive coil causes the magnetic field generated by the drive coil to be oriented substantially normal to the surface being tested.

A sensor is coupled to the drive coil to receive secondary fields. Secondary fields of interest are received at the sensor after the magnetic fields generated by the drive coil are reflected from a surface flaw on, or in, the surface being tested. The sensor is configured to convert the reflected secondary field into an electric signal that may be viewed and/or recorded.

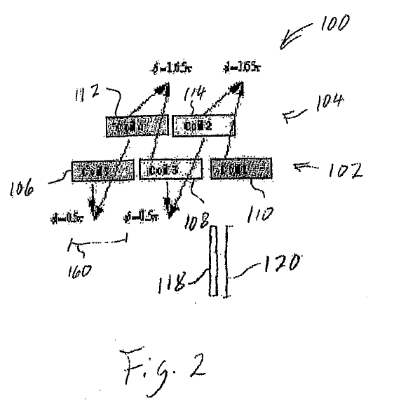

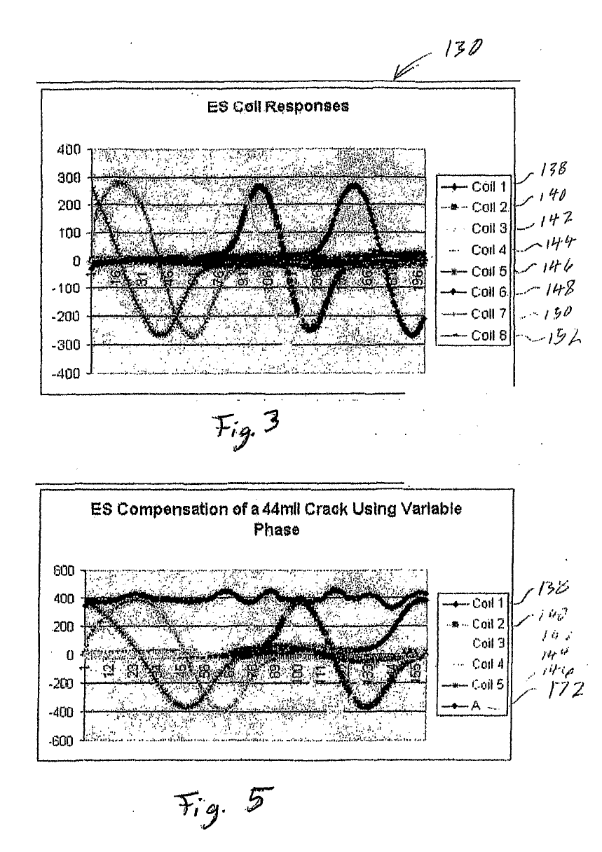

Examples of specific types of EC probes 70 are, but are not limited to, a Sense External (ES) ECAP, a Long Standard Probe (LSP) ECAP, and an omni-directional ECAP. FIG. 2 illustrates an exemplary Sense External (ES) 100 type ECAP. ES ECAP 100 includes a first row of EC coils 102, also referred to as EC elements, and a second row of EC coils 104. FIG. 3 is an exemplary ECAP image 130 produced from defect response data collected by ES ECAP 100. First row 102 includes a plurality of EC coils, for example, EC coil 106, EC coil 108, and EC coil 110. Second row 104 also includes a plurality of EC coils, for example, EC coil 112 and EC coil 114.

As described above with respect to ECAP images in general, images produced by ES ECAP 100 have to be processed prior to flaw detection and characterization since a defect 118 seen during a scan using ES ECAP 100 is seen only in part by individual EC coils 106, 108, 110, 112, and 114. ECAP image 130 is also referred to as an ECAP footprint and represents a plot of the maximum responses generated by adjacent array elements when ES ECAP 100 scans a defect at specific increments. ECAP footprint 130 includes a plurality of partial defect responses, for example responses 138, 140, 142, 144, 146, 148, 150, and 152. Each partial defect response 138, 140, 142, 144, 146, 148, 150, and 152 is received by an EC coil of ES ECAP 100.

To identify a defect 118, and to predict a length 120 of the defect 118, partial defect responses 138, 140, 142, 144, 146, 148, 150, and 152 are modeled as mathematical functions, to produce a single maximum defect response (not shown in FIG. 2 or 3). Regardless of an orientation of defect 118 and/or of a relative position of defect 118 along a width, for example, a width 160 (shown in FIG. 2) of each EC coil, for example, EC coil 106. The single maximum defect response (not shown in FIG. 2 or 3) is used to predict a length 120 of each detected defect 118. Using an appropriate compensation measure enables determination of the single maximum defect response from the plurality of partial defect responses measured by ES ECAP 100.

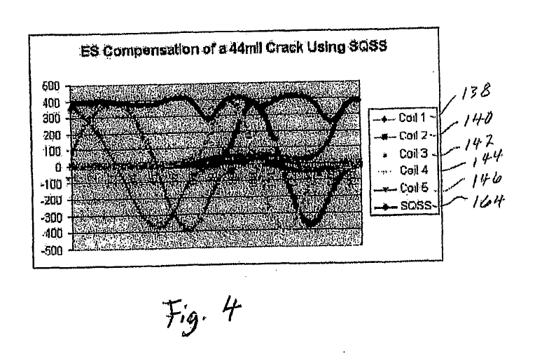

An example of a compensation measure that may be used to produce a single maximum defect response is to apply a square of the sum of squares (SQSS) compensation technique. FIG. 4 illustrates the result of a SQSS compensation technique when applied to footprint 130 (shown in FIG. 3). A maximum defect response 164 is illustrated. Partial defect responses 138, 140, 142, 144, and 146 are also illustrated.

In the exemplary embodiment, maximum defect response 164 is calculated using the following equation:

$$A = \sqrt{{\sum }_{i = 0}^{N} {p}_{i}} ⋀ 2 \qquad ( Equation 1 )$$

At any point in time within footprint 130, there are only two significant coil responses. Equation 1 can be reduced to Equation 2 (see below), wherein p₁ and p₂ are the two most significant coil responses, and wherein the most significant coil responses are defined as the coil responses having the highest amplitude at that particular time:

A=\sqrt{p₁̂2+p₂̂2} (Equation 2)

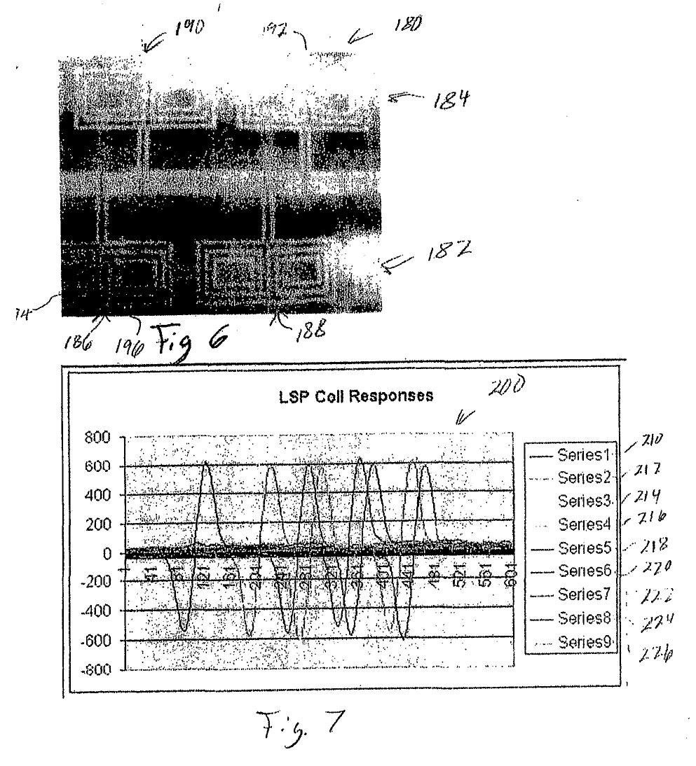

Another example of compensation that may be used to produce a single maximum defect response is to apply a variable phase compensation technique. FIG. 5 illustrates the result of a variable phase compensation technique when applied to footprint 130 (shown in FIG. 3). A maximum defect response 172 is illustrated. Partial defect responses 138, 140, 142, 144, and 146 are also illustrated.

Notably, in such a technique, partial defect responses 138, 140, 142, 144, and 146 can be approximated to sine curves. Maximum defect response 172 is calculated by shifting partial defect responses 138, 140, 142, 144, and 146 by a particular phase depending on whether the responses belong to the same coil pair or different coil pairs. Partial defect responses 138, 140, 142, 144, and 146 each have different phases due to the physical configuration of ES ECAP 100. The SQSS compensation technique described herein is an exemplary embodiment to compensate sine waves that differ in phase by 90°. Coils 106, 108, 110, 112, and 114 of ES ECAP 100 respond to produce responses with two different phase shifts. The variable phase compensation technique includes compensating responses 138, 140, 142, 144, and 146 using the following equations:

$$\begin{matrix}{p}_{1} = A sin ( x ) & ( Equation 3 ) \\ {p}_{2} = A sin ( x + φ ) & ( Equation 4 ) \\ A = \frac{{p}_{1} - {p}_{2} ⋆ cos ( φ ) ⋀ 2}{sin ( φ )} + {p}_{2} ⋀ 2 & ( Equation 5 )\end{matrix}$$

wherein p₁ and p₂ are the maximum amplitude values. Given the respective phase difference, ø, between the coils to which the maximum amplitudes belong, for example, coils 106 and 112, compensated value, A, can be calculated for every position on the array probe using Equation 5.

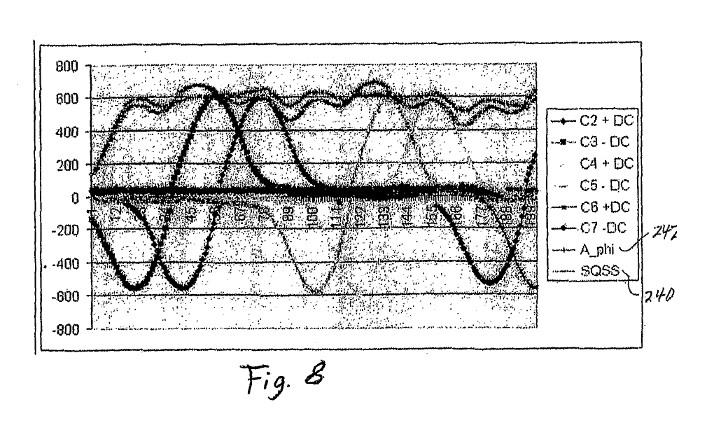

FIG. 6 illustrates an exemplary LSP ECAP 180. LSP ECAP 180 includes a first row a EC elements 182 and a second row of EC elements 184. FIG. 7 is an exemplary EC image 200, also referred to herein as EC footprint 200, produced from defect response data collected by LSP ECAP 180. First row 182 includes a plurality of EC elements, for example, EC element 186 and EC element 188. Second row 184 also includes a plurality of EC elements, for example, EC element 190 and EC element 192. Each of EC elements 186, 188, 190, and 192 includes two coils having opposing polarities. For example, EC element 186 includes a first coil 194 and a second coil 196, wherein first coil 194 is of an opposite polarity as second coil 196.

As described above with respect to partial defect responses 138, 140, 142, 144, and 146 produced by ES ECAP 100, in the exemplary embodiment, partial defect responses 210, 212, 214, 216, 218, 220, 222, 224, and 226 collected by LSP ECAP 180 can be approximated to sine curves. Partial defect responses 210, 212, 214, 216, 218, 220, 222, 224, and 226 occur in pairs, for example, responses 212 and 214 and responses 216 and 218. In an exemplary embodiment, defect responses within a pair are phase shifted by approximately 99°. In the exemplary embodiment, the phase difference between defect responses pairs is approximately 285°. The SQSS compensation technique and the variable phase compensation technique described above with respect to ES ECAP 100 may be applied to partial responses 210, 212, 214, 216, 218, 220, 222, 224, and 226 produced by LSP ECAP 180.

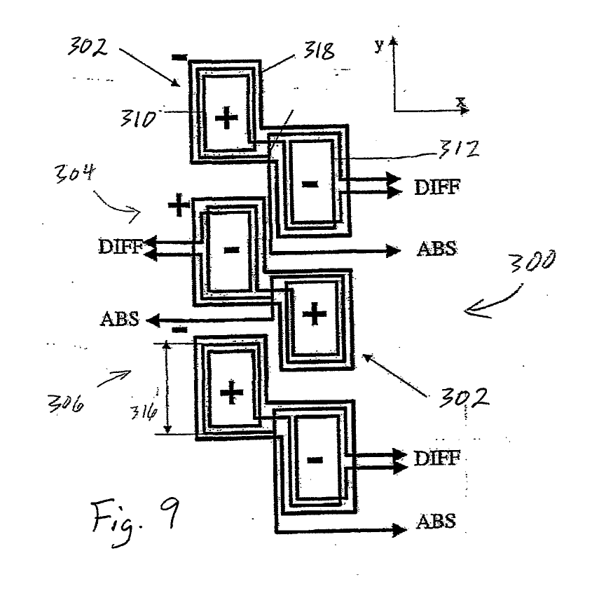

FIG. 8 illustrates the result of the SQSS compensation technique and the variable phase compensation technique when applied to footprint 200 (shown in FIG. 7). The SQSS compensation technique described herein produces a maximum defect response 240 and the variable phase compensation technique described above produces a maximum defect response 242. Maximum defect responses 240 and 242 are used to predict a length of the detected defect.

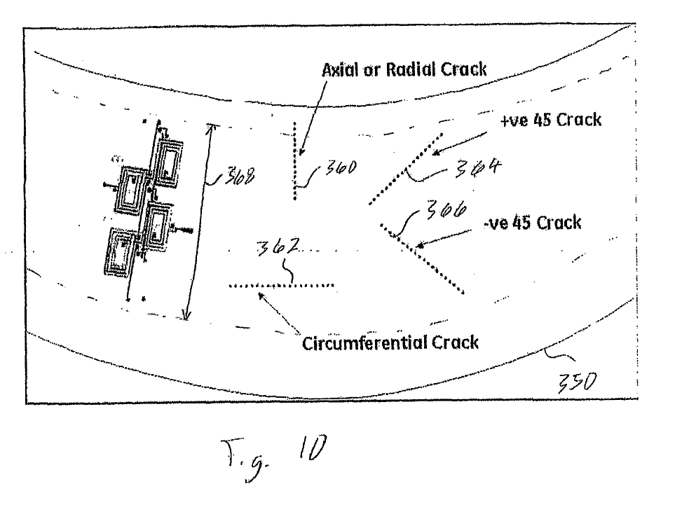

FIG. 9 illustrates an exemplary omni-directional ECAP 300. Unlike ES ECAP 100 and LSP ECAP 180, omni-direction ECAP 300 includes only one row of EC elements, for example, EC elements 302, 304, and 306, and there is an overlap of coils of positive and negative polarities. In the exemplary embodiment, EC element 302 includes a first sense coil 310 and a second sense coil 312. First and second sense coils 310 and 312 are offset from each other in a first (X) direction and in a second (Y) direction and overlap one another in either the first and/or second directions (X,Y). As used herein, the terms “offset” and “overlap” are not mutually exclusive. For example, in the exemplary embodiment, first and second sense coils 310 and 312 are both offset and overlap in the Y direction. In other words, in such an orientation, first and second sense coils 310 and 312 are partially offset in the (Y) direction, whereas they are completely offset (i.e., with no overlap) in the (X) direction. In one embodiment, first and second sense coils 310 and 312 overlap in second direction (Y) by at least about twenty-five percent (25%) of a length 316 of each sense coil 310 and 312. In another embodiment, first and second sense coils 310 and 312 overlap in the second direction (Y) by at least about thirty-three percent (33%) of a length 316 of each sense coil 310 and 312. In another embodiment, first and second sense coils 310 and 312 overlap in second direction (Y) by at least about fifty percent (50%) of length 316.

Omni-directional EC probe 300 also includes at least one drive coil 318 that generates a probing field for EC channel 302 in a vicinity of first and second sensing coils 310 and 312. In the exemplary embodiment, drive coil 318 extends around first and second sense coils 310 and 312 and forms EC channel 302.

To enhance scanning of a relatively large surface area, an array of EC channels 302 is used. Accordingly, the exemplary omni-directional EC probe 300 includes a number of EC channels 302 and a number of drive coils 318. Specifically, in the exemplary embodiment, at least one drive coil 318 is provided for each EC channel 302.

In the exemplary embodiment, the overlapping orientation of first and second sense coils 310 and 312 enables omni-directional EC probe 300 to detect imperfections in a component being tested anywhere along the (Y) direction. However, omni-directional EC probe 300 may include any orientation of EC channels 302 that enables EC probe 300 to function as described herein. By including a plurality of EC channels 302 that are substantially identical, performance of the plurality of EC channels 302 is facilitated to be substantially uniform.

As described above, omni-directional EC array probe 300 is used to detect surface, or near surface, cracks (i.e., surface connected flaws) in conductive components, such as, but not limited to, aircraft engine components including disks, spools, and blades. Exemplary components are formed of nickel alloys and titanium alloys. However, EC probe 300 may be used with a variety of conductive components.

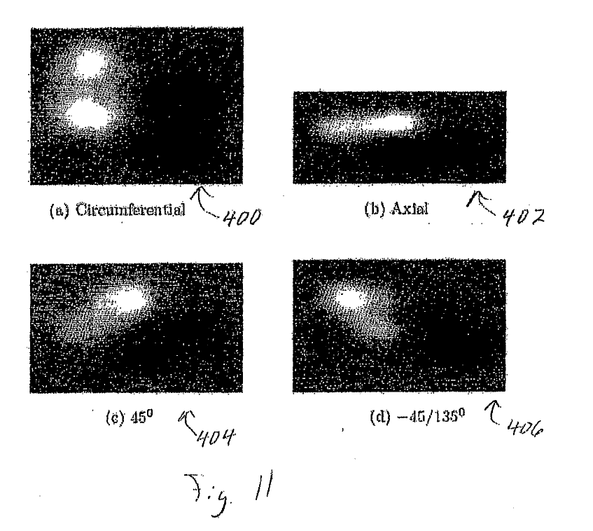

FIG. 10 is a plan view of an exemplary component 350 that includes a plurality of exemplary defects. For example, in the exemplary embodiment, component 350 includes a radial/axial defect 360, a circumferential defect 362, and two angled defects 364 and 366. Radial defect 360, circumferential defect 362, and angled defects 364 and 366 are examples of different defect orientations that may occur within component 350. An exemplary EC probe path is illustrated at 368. As described in more detail below, radial defect 360, circumferential defect 362, and angled defects 364 and 366 respond differently to omni-directional ECAP 300, in terms of a maximum amplitude of the response and a signature of the response.

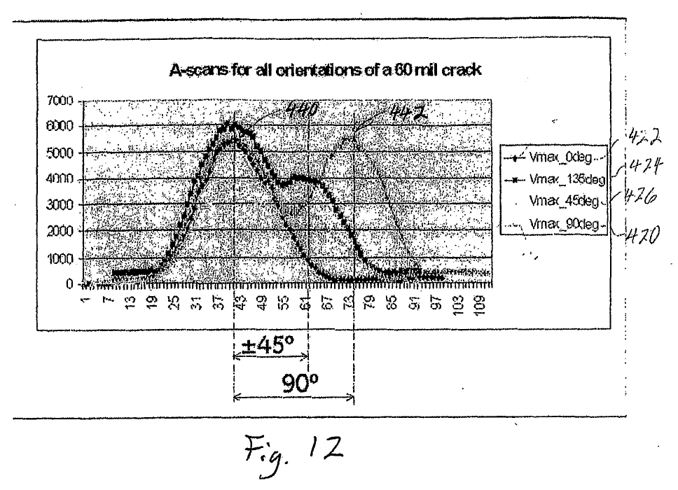

As described above with respect to ES ECAP image 130 (shown in FIGS. 3-5) and LSP ECAP image 200 (shown in FIG. 7), images produced by omni-directional ECAP 300 have to be processed prior to flaw detection and characterization since a defect seen during a scan using omni-directional ECAP 300 is seen only in part by each of EC elements 302, 304, and 306. FIG. 11 illustrates four exemplary footprints 400, 402, 404, and 406 produced from defect response data collected by omni-directional ECAP 300. Footprint 400 is generated by responses to a circumferential defect, such as, for example, circumferential defect 362 (shown in FIG. 10). Footprint 402 is generated by responses to a radial/axial defect, such as, for example radial/axial defect 360 (shown in FIG. 10). Footprints 404 and 406 are generated by responses to angled defects, such as, for example, angled defects 364 and 366 (shown in FIG. 10).

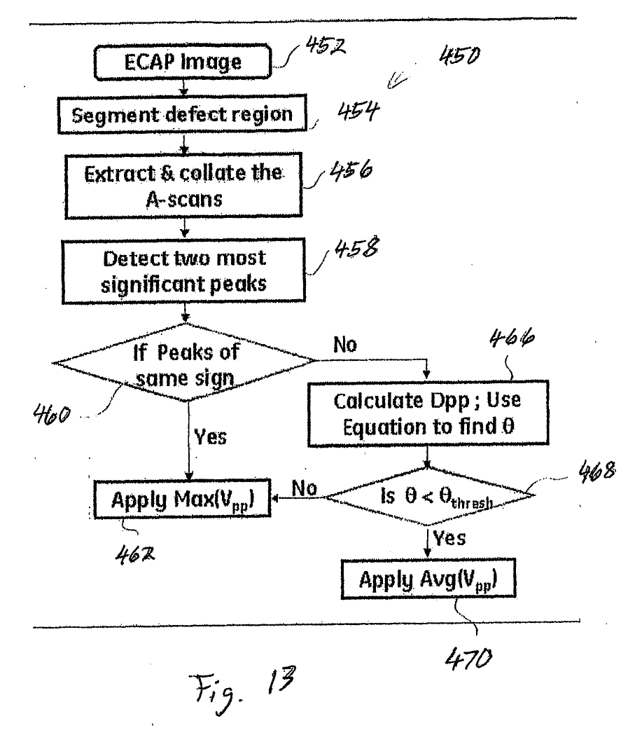

From each footprint 400, 402, 404, and 406, an A-scan of maximum voltage received by a positive element of omni-directional ECAP 300 may be produced. For example, FIG. 12 illustrates four exemplary A-scans produced from footprints 400, 402, 404, and 406. More specifically, an A-scan 420 illustrates maximum voltages obtained from circumferential footprint 400. An A-scan 422 illustrates maximum voltages obtained from radial/axial footprint 402. An A-scan 424 illustrates maximum voltages obtained from angled defect 406 and an A-scan 426 illustrates maximum voltages obtained from angled defect 404. Notably, A-scan 420, which corresponds to a circumferential defect, includes two distinct peaks, visible at locations 440 and 442. Whereas, A-scan 422, which corresponds to a radial/axial defect, includes two overlapping peaks, visible at location 440.

FIG. 13 is a flow chart of an exemplary compensation technique 450 for use with partial defect responses produced by an omni-directional ECAP, such as, omni-directional ECAP 300 (shown in FIG. 9). Unlike ES ECAP 100 and LSP ECAP 180 (shown in FIGS. 2 and 6, respectively), which are unidirectional (i.e., able to detect a defect in one orientation relative to the ECAP), omni-directional ECAP 300 is able to detect a defect of any orientation relative to omni-directional ECAP 300. Compensation technique 450 enables the approximation of an orientation of a detected defect, along with a length of the detected defect. In the exemplary embodiment, compensation technique 450 uses a maximum peak-to-peak voltage (MaxVₚₚ) to determine a single maximum defect response. Alternatively, relying upon an average peak-to-peak voltage (AvgVₚₚ), or a combination of Max(Vₚₚ) and Avg(Vₚₚ), may also provide an effective compensation. The combination of Max(Vₚₚ) and Avg(Vₚₚ) used to determine a single maximum defect response is selected based on the orientation of the defect with respect to the ECAP. Therefore, to apply compensation to responses produced by omni-directional ECAP 300, the orientation of the defect must be determined.

Compensating the responses produced by omni-directional ECAP 300 may be accomplished using the following equation:

A=αMax(Vₚₚ)+βAvg(Vₚₚ) (α,β)ε[0,1] (Equation 6)

wherein α and β are weights attached to Max(Vₚₚ) and Avg(Vₚₚ), respectively. As described further below, in one example, when a defect is determined to be of a circumferential orientation, compensation values, A, may be calculated by applying α=1, and β=0.

Compensation technique 450 enables the determination of an orientation of a defect detected by an omni-directional ECAP. Determining the orientation of a defect enables the determination of values for α and β, for use in Equation 6 to calculate a single maximum defect response. Technique 450 includes capturing 452 an ECAP image, for example, footprints 400, 402, 404, and 406 (each shown in FIG. 11), using omni-directional ECAP 300. A defect response region is segmented 454 and an A-scan, for example one of A-scans 420, 422, 424, and 426 (each shown in FIG. 12) is extracted and collated 456 from the captured ECAP image. Significant peaks within the extracted A-scan are identified 458. Significant peaks refer to the largest positive peak and the largest negative peak.

Compensation technique 450 also includes comparing 460 the signs of the significant peaks. If the significant peaks are either both positive or both negative, α is given a value of 1 and β is given a value of 0. Therefore, Max(Vₚₚ) values are applied 462 to obtain a single maximum defect response when there is an absence of a positive-negative pair of peaks.

If the significant peaks are of opposite polarity, a distance between the significant peaks (Dₚₚ) is determined 466. In one embodiment, Dpp is measured in scan index units. The Dₚₚ of a collected A-scan is indicative of the orientation of the detected defect. From the measured Dₚₚ value, an angle, θ, can be determined using the following equation:

Dₚₚ=|θ|/4+29.5 (Equation 7)

Angle θ corresponds to the orientation of the detected defect. Since neither the compensation technique using Max(Vₚₚ), nor the compensation technique using Avg(Vₚₚ), are directly dependent upon the angle between the detected defect and the ECAP, an exact determination of that angle is not necessary.

Once angle θ is calculated, it is compared 468 to a threshold angle, θₜₕᵣₑₛₕ. If θ is less than θₜₕᵣₑₛₕ, the compensation technique using Avg(Vₚₚ) values is applied 470. If θ is greater than θₜₕᵣₑₛₕ, the compensation technique using Max(Vₚₚ) is applied 462. More specifically, if 0°<θ<θₜₕᵣₑₛₕ, then α=0, β=1 is substituted into Equation 6. If θₜₕᵣₑₛₕ<θ, then α=1, β=0 is substituted into Equation 6. In an exemplary embodiment, θₜₕᵣₑₛₕ is selected to be 45°. In the exemplary embodiment, if θ<45°, the detected defect is closer to a radial/axial defect than to a circumferential defect, and as stated above, the Avg(Vₚₚ) compensation technique produces a desired maximum detected response for that type of defect. If 45°<θ, the detected defect is closer to a circumferential defect than a radial/axial defect, and as also is stated above, the Max(Vₚₚ) compensation technique produces a desired maximum detected response for that type of defect.

However, θₜₕᵣₑₛₕ may be set at any angle between 0° and 90°, and a θₜₕᵣₑₛₕ may be determined through calculation and/or experimentation to provide an accurate determination as to whether the Max(Vₚₚ) compensation technique or the Avg(Vₚₚ) compensation technique produces a single maximum detected response that more accurately identifies a length of a detected defect. Furthermore, neither weight factor α nor weight factor β are required to be binary. For angled defects, for example, angled defects 364 and 366, weight factors α and β may be calculated to allow a single maximum response to be determined using a combination of the Max(Vₚₚ) compensation technique and the Avg(Vₚₚ) compensation technique.

Different compensation techniques have been developed and tested to cater to different ECAPs, such as, for example, a LSP ECAP, an ES ECAP, and an omni-directional ECAP. Compensation techniques developed for the LSP and ES ECAP, for example, the SQSS compensation technique and the variable phase compensation technique, are unidirectional and facilitate calculation of a single maximum defect response from a plurality of sinusoids shifted from each other by a phase hardwired to the configuration of the ECAP elements. For the omni-directional ECAP, a defect orientation is estimated before normalization. The defect orientation is estimated from the 1-D signal response (A-Scan) of an ECAP image obtained by the omni-directional ECAP. The distance between significant peaks (Dₚₚ) within the A-scans are independent of the defect length, but indicative of defect orientation and hence are used to estimate defect orientation. A weighted sum of the Average and Maximum peak-to-peak voltages is used to normalize A-scans of an ECAP image. The estimated orientation determines the weight given to Max(Vₚₚ) and Avg(Vₚₚ) used in the aforementioned equation.

The above description of methods for compensating detected results of scans using eddy current array probes may also be extended to single-coil EC inspections. The above described compensation may correct single-coil EC defect responses, by reducing a characterization error due to finite scan increments.

The above-described compensation techniques are tailored to various ECAP designs. The compensation techniques may be selected based on the ECAP in use and/or based on defect orientation information. Once the desired compensation technique is selected and applied, the defect region is segmented out and a single maximum defect response is determined that corresponds to a potential defect length. By applying the compensation techniques described above, an improved correlation between the EC response and defect length is obtained.

Exemplary embodiments of eddy current inspection compensation techniques are described above in detail. The processes and systems are not limited to the specific embodiments described herein, but rather, components of each system and steps within each process may be utilized independently and separately from other components and steps described herein. More specifically, although the processes and systems herein are described with respect to inspection of aircraft engine components, it should be appreciated that the processes and systems can also be applied to a wide variety of components used within a steam turbine, a nuclear power plant, an automotive engine, or to inspect any mechanical component.

While the invention has been described in terms of various specific embodiments, those skilled in the art will recognize that the invention can be practiced with modification within the spirit and scope of the claims.

1. A method of inspecting a component using an eddy current array probe (ECAP), said method comprising:
scanning a surface of the component with the ECAP;
collecting, with the ECAP, a plurality of partial defect responses;
transferring the plurality of partial defect responses to a processor;
modeling the plurality of partial defect responses as mathematical functions based on at least one of a configuration of elements of the ECAP and a resolution of the elements; and
producing a single maximum defect response from the plurality of partial defect responses.

2. A method according to claim 1 further comprising determining an approximate length of a defect based on the single maximum defect response.

3. A method according to claim 1, wherein producing a single maximum defect response further comprises compensating the plurality of partial defect responses without using a look-up table to obtain a single maximum defect response or an approximate defect length.

4. A method according to claim 1, wherein producing a single maximum defect response further comprises using a square of the sum of squares (SQSS) compensation technique to produce the single maximum defect response, using the following equation:
A=\sqrt{p₁̂2+p₂̂2}
wherein p₁ and p₂ are maximum amplitude values at predetermined scan positions, and a compensated value, A, is calculated for each of the predetermined scan positions.

5. A method according to claim 1, wherein producing a single maximum defect response further comprises using a variable phase compensation technique to produce the single maximum defect response, using the following equation:
$$A = \frac{{p}_{1} - {p}_{2} ⋆ cos ( φ ) ⋀ 2}{sin ( φ )} + {p}_{2} ⋀ 2$$
wherein p₁ and p₂ are maximum amplitude values at predetermined scan positions, and ø is a phase difference between coils of said ECAP, and wherein a compensated value, A, is calculated for each of the predetermined scan positions.

6. A method according to claim 1 further comprising estimating an orientation of a defect detected by the ECAP.

7. A method according to claim 6, wherein estimating the orientation of a defect comprises:
capturing an ECAP image using an omni-directional ECAP;
extracting an A-scan from the captured ECAP image;
determining a distance between significant peaks of the A-scan; and
calculating a defect angle based on the distance between significant peaks.

8. A method according to claim 6 further comprising applying at least one of a maximum voltage peak-to-peak compensation technique and an average voltage peak-to-peak compensation technique to the plurality of partial defect responses based on the estimated orientation of the defect.

9. A method according to claim 6, wherein producing a single maximum defect response from the plurality of partial defect responses further comprises analyzing a maximum voltage peak-to-peak of the ECAP image when the defect orientation is estimated to be closer to a circumferential orientation with respect to the ECAP than a radial/axial orientation.

10. A method according to claim 6, wherein producing a single maximum defect response from the plurality of partial defect responses further comprises analyzing an average voltage peak-to-peak of the ECAP image when the defect orientation is estimated to be closer to a radial/axial orientation with respect to the ECAP than a circumferential orientation.

11. A method of estimating a length of a defect detected by an eddy current array probe (ECAP), said method comprising:
modeling a plurality of partial defect responses received from the ECAP as mathematical functions based on at least one of a configuration of elements of the ECAP and a resolution of the elements;
applying a compensation technique to the plurality of partial defect responses to produce a single maximum defect response; and
determining an estimated length of the defect based on the single maximum defect response.

12. A system for non-destructive testing of a component, said system configured to detect the presence of defects on a surface of and/or within said component and estimate a length of at least one defect, said system comprising:
an eddy current (EC) probe configured to produce an EC image of said component; and
a processor coupled to said EC probe, said processor configured to receive the EC image from said EC probe and to obtain a single maximum defect response.

13. A system according to claim 12, wherein said processor is further configured to determine an estimated length of a detected defect based on said single maximum defect response.

14. A system according to claim 13, wherein said processor is configured to apply at least one compensation technique to the EC image to obtain the single maximum defect response without using a look-up table to obtain the single maximum defect response or an approximate defect length.

15. A system according to claim 12, wherein said processor is configured to apply a square of the sum of squares (SQSS) compensation technique, wherein a single maximum defect response is obtained using the following equation:
A=\sqrt{p₁̂2+p₂̂2}
wherein p₁ and p₂ are maximum amplitude values at predetermined scan positions, and a compensated value, A, is calculated for each of said predetermined scan positions.

16. A system according to claim 12, wherein said processor is configured to apply a variable phase compensation technique, wherein a single maximum defect response is obtained using the following equation:
$$A = \frac{{p}_{1} - {p}_{2} ⋆ cos ( φ ) ⋀ 2}{sin ( φ )} + {p}_{2} ⋀ 2$$
wherein p₁ and p₂ are maximum amplitude values at predetermined scan positions, and ø is a phase difference between coils of said EC probe, and wherein a compensated value, A, is calculated for each of said predetermined scan positions.

17. A system according to claim 12, wherein said EC probe comprises at least one of a sense external (ES) eddy current array probe (ECAP), a long standard probe (LSP) ECAP, and an omni-directional ECAP.

18. A system according to claim 17, wherein said processor is configured to estimate an orientation of a defect detected by said ECAP by:
extracting an A-scan from said EC image received from an omni-directional ECAP;
determining a distance between significant peaks of said A-scan; and
calculating a defect angle using said distance between significant peaks.

19. A system according to claim 17 wherein said processor is further configured to apply at least one of a maximum voltage peak-to-peak compensation technique and an average voltage peak-to-peak compensation technique to said plurality of partial defect responses based on said estimated orientation of the defect.

20. A system according to claim 17, wherein said processor is further configured to apply a compensation technique to produce said single maximum defect response by analyzing at least one of a maximum voltage peak-to-peak of said ECAP image and an average voltage peak-to-peak of said ECAP image, levels of said maximum voltage and said average voltage determined by said estimated defect orientation.
